(19) United States
(12) Patent Application Publication
(10) Pub. No.: US 2005/0131687 A1
(43) Pub. Date: Jun. 16, 2005

(54) Portable wire-less communication device

(75) Inventor: Andrea Sorrentino, Twickenham (GB)

Correspondence Address: FITZPATRICK CELLA HARPER & SCINTO, 30 ROCKEFELLER PLAZA, NEW YORK, NY, 10112, US

(73) Assignee: CANON EUROPA N.V., Amstelveen (NL)

(21) Appl. No.: 10/948,263

(22) Filed: Sep. 24, 2004

(30) Foreign Application Priority Data
Sep. 25, 2003 (GB) 0322516.6
Apr. 16, 2004 (GB) 0408536.1

(51) Int. Cl. G10L 15/26

(52) U.S. Cl. 704/235

(57) ABSTRACT

A cellular telephone is described which includes a predictive text editor for generating text messages in response to key-presses made on an ambiguous keyboard of the cellular telephone. The text editor also includes a speech recogniser for recognising words in speech input by the user to disambiguate between possible words corresponding to key-presses made by the user on the ambiguous keyboard.

This application claims the right of priority under 35 USC Section 119 based on UK Patent Application Numbers 0322516.6 filed 25 Sep. 2003, and 0408536.1 filed 16 Apr. 2004, which are hereby incorporated by reference herein in their entirety as if fully set forth herein.

The present invention relates to portable wire-less communication devices, such as cellular telephones, and in particular to the generation of text using such devices for use, for example, in text messages.

The short Messaging Service (SMS) allows text messages to be sent and received on cellular telephones. The text message can comprise words or numbers and is generated using a text editor module on the cellular telephone. SMS was created as part of the GSM Phase One standard and allows for up to one hundred and sixty characters to be transmitted in a single message.

When creating a message, the user enters the characters for the message via a keyboard associated with the cellular telephone. Typically, the keyboard on the cellular telephones has ten keys corresponding to the ten digits “0” to “9” and further keys for controlling the operation of the telephone such as “place call”, “end call” etc. To facilitate entry of letters and punctuation, for example, when composing a text message, the characters of the alphabet are divided into subsets and each subset is mapped to a different key of the keyboard. As there is not a one to one mapping between the characters of the alphabet and the keys of the keyboard, the keyboard can be said to be an “ambiguous keyboard”.

The text editor on the cellular telephone must therefore have some mechanism to disambiguate between the different letters associated with the same key. For example, in mobile telephones typically employed in Europe, the key corresponding to the digit “2” is also associated with the characters “A”, “B” and “C”. The two well known techniques for disambiguating letters typed on such an ambiguous keyboard are known as “multi-tap”, and “predictive text”. In the multi-tap” system, the user presses each key a number of times depending on the letter that the user wants to enter. For the above example, pressing the key corresponding to the digit “2” once gives the character “A”, pressing the key twice gives the character “B”, and pressing the key three times gives the character “C”. Usually there is a predetermined amount of time within which the multiple key strokes must be entered. This allows for the key to be re-used for another letter when necessary.

When using a cellular telephone having a predictive text editor, the user enters a word by pressing the keys corresponding to each letter of the word exactly once and the text editor includes a dictionary which defines the words which may correspond to the sequence of key presses. For example, if the keyboard contains (like most cellular telephones) the keys “ ”, “ABC”, “DEF”, “GHI”, “JKL”, “MNO”, “PQRS”, “TUV” and “WXYZ” and the user wants to enter the word “hello”, then he does this by pressing the keys “GHI”, “DEF”, “TKL”, “JKL”, “MNO” and “ ”. The predictive text editor then uses the stored dictionary to disambiguate the sequence of keys pressed by the user into possible words. The dictionary also includes frequency of use statistics associated with each word which allows the predictive text editor to choose the most likely word corresponding to the sequence of keys. If the predicted word is wrong then the user can scroll through a menu of possible words to select the correct word.

Cellular telephones having predictive text editors are becoming more popular because they reduce the number of key presses required to enter a given word compared to those that use multi-tap text editors. However, one of the problems with predictive text editors is that there are a large number of short words which map to the same key sequence. A dedicated key must, therefore be provided on the keyboard for allowing the user to scroll through the list of matching words corresponding to the key presses, if the predictive text editor does not predict the correct word.

It is an aim of the present invention to increase the speed and ease of generating text messages on a cellular communications device having an ambiguous keyboard.

In one aspect, the present invention provides a cellular telephone having a text editor for generating text messages for transmission to other users. The cellular telephone also includes a speech recognition circuit which can perform speech recognition on input speech and which can provide a recognition result to the text editor for display to the user on a display of the cellular telephone. In this way, the text editor can generate text for display either from key-presses input by the user on a keypad of the telephone or in response to a recognition result generated by the speech recognition circuit.

In another aspect, the present invention provides a cellular device having speech recognition means for performing speech recognition on a speech sample containing a word the user desires to be entered into a text editor, the speech recognition means having a grammar that is constrained in accordance with previous key presses made by the user.

Exemplary embodiments of the present invention will now be described with reference to the accompanying drawings, in which:

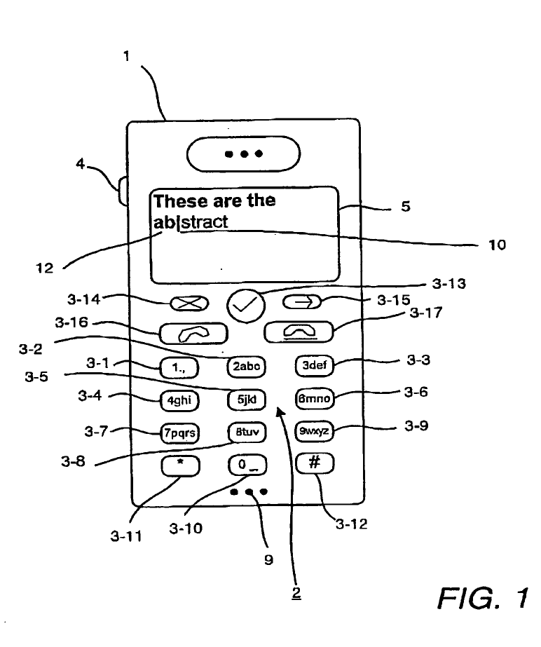

FIG. 1 shows a cellular telephone having an ambiguous keyboard for both number and letter entry;

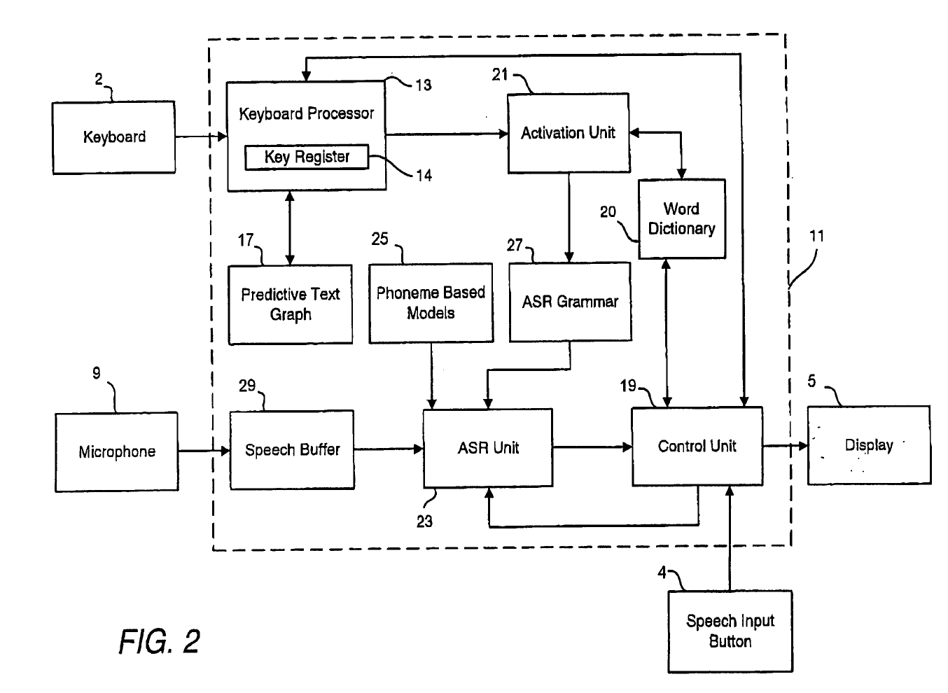

FIG. 2 is a block diagram illustrating the main functional components of a text editor which forms part of the cellular telephone shown in FIG. 1;

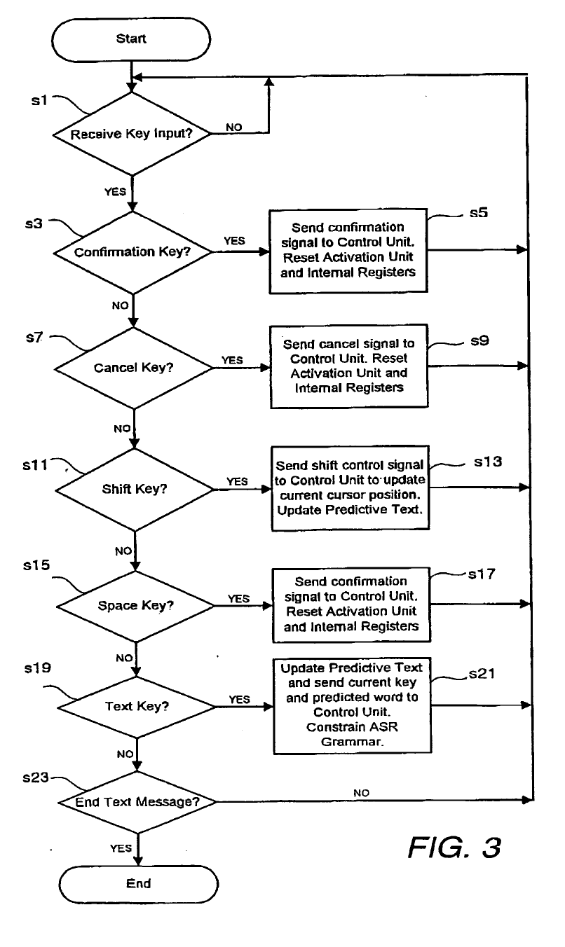

FIG. 3 is a flowchart illustrating the main processing steps performed by a keyboard processor shown in FIG. 2 in response to receiving a keystroke input from the cellular telephone keyboard;

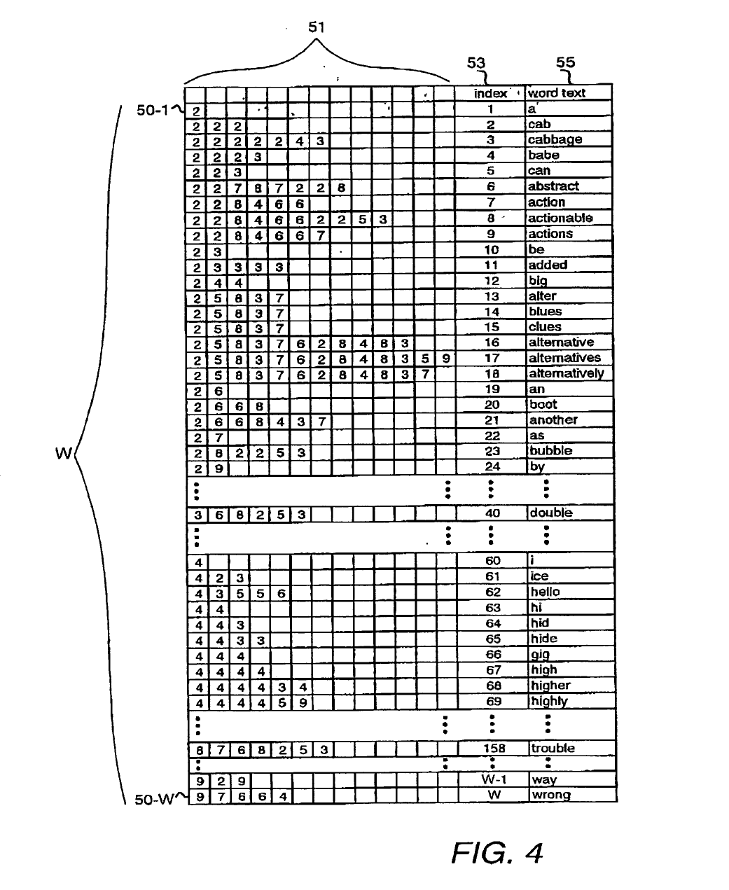

FIG. 4 is a table illustrating part of the data used to generate a predictive text graph and a word dictionary shown in FIG. 2;

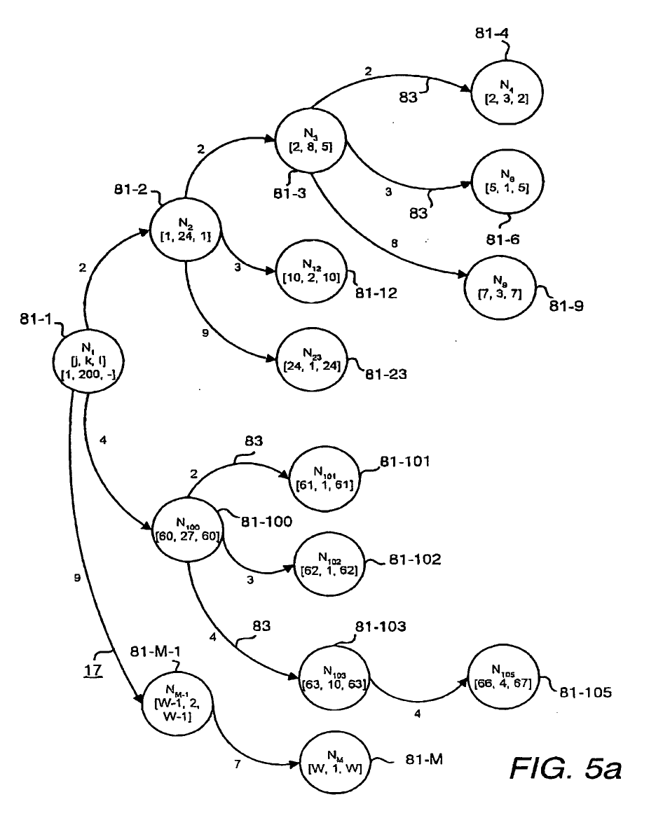

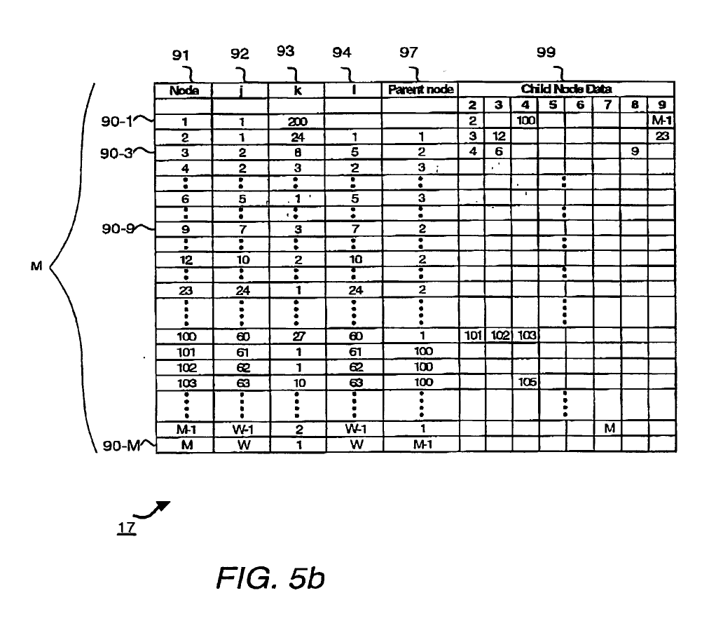

FIG. 5a schematically illustrates part of a predictive text graph generated from the data in the table shown in FIG. 4;

FIG. 5b illustrates the predictive text graph shown in FIG. 5a in tabular form;

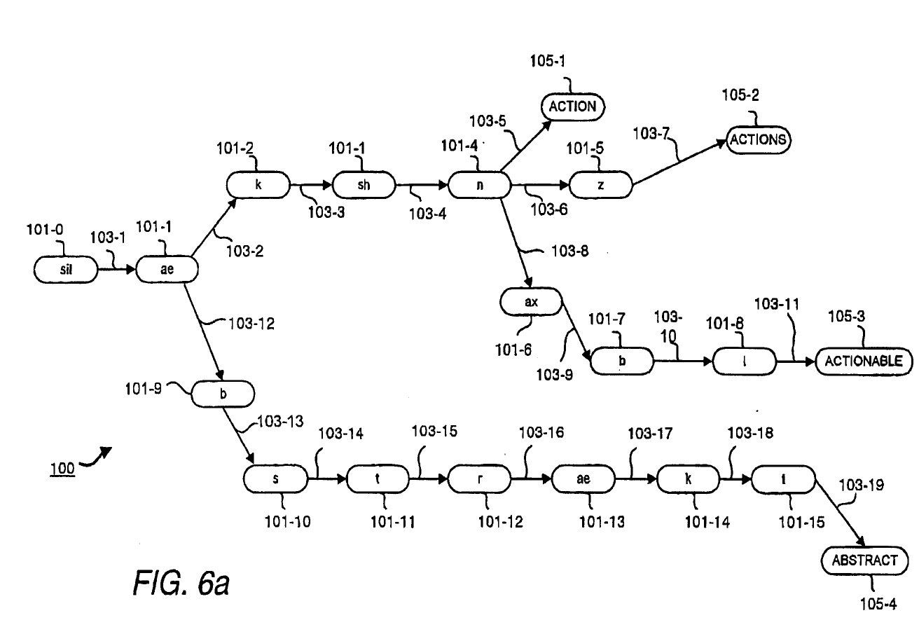

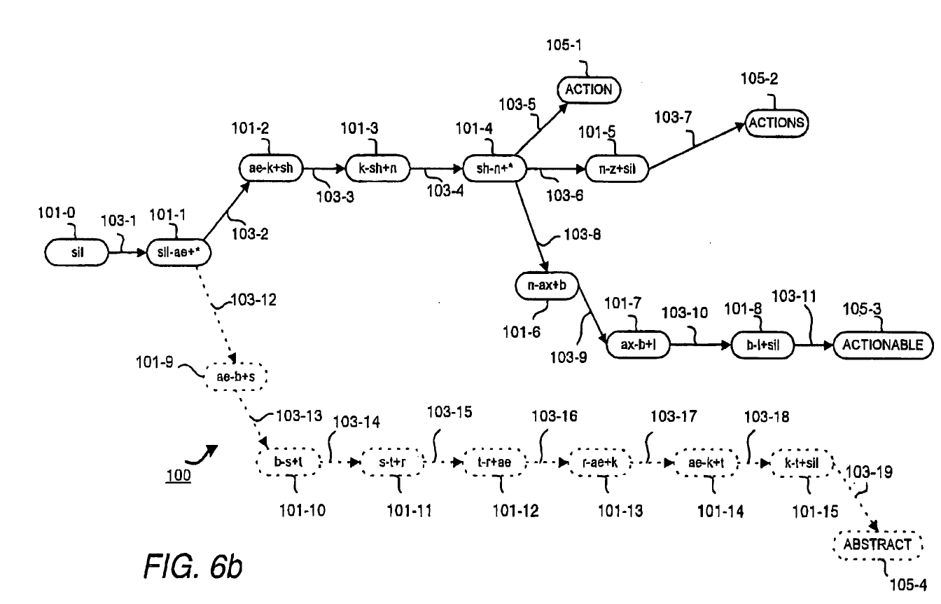

FIG. 6a illustrates part of an ASR grammar defined with context independent phonemes;

FIG. 6b illustrates a portion of a grammar used by an automatic speech recognition circuit which forms part of IS the text editor shown in FIG. 2;

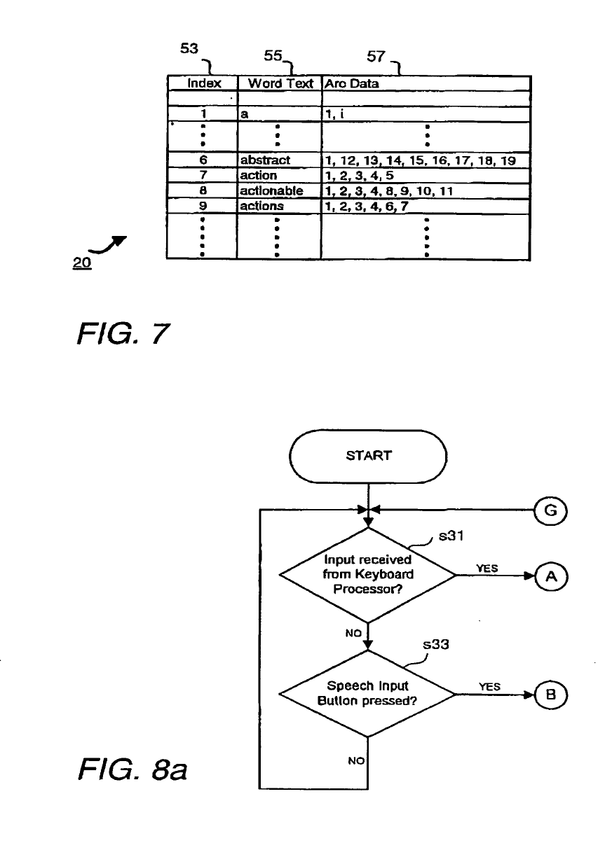

FIG. 7 is a table illustrating the form of the word dictionary shown in FIG. 2;

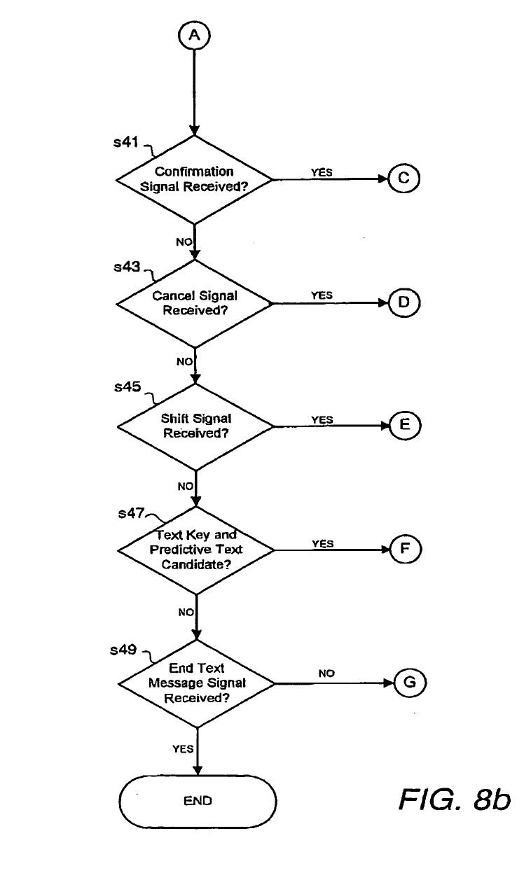

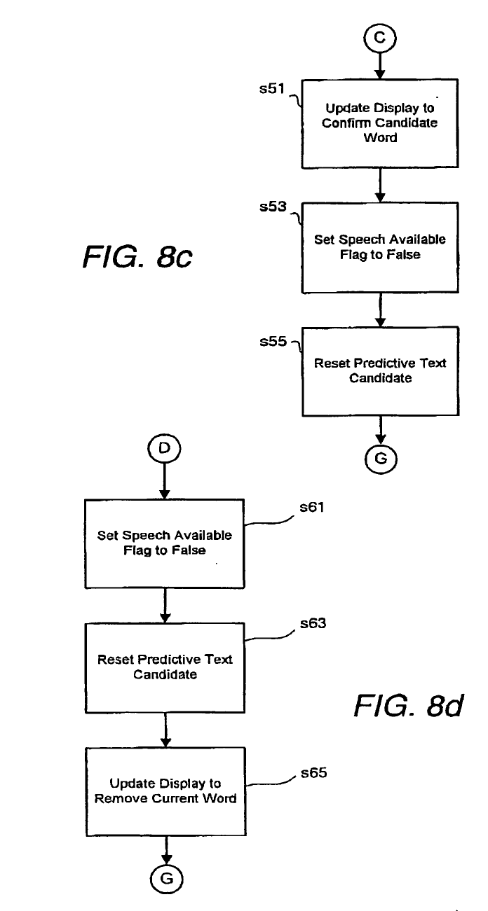

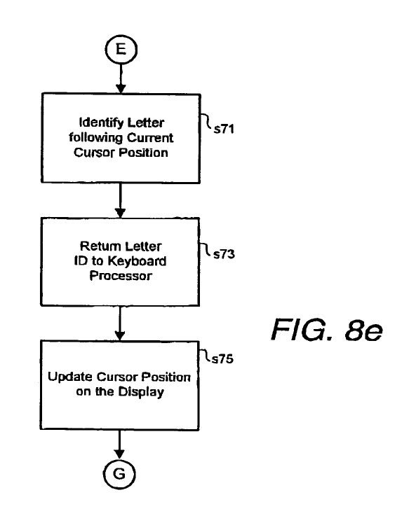

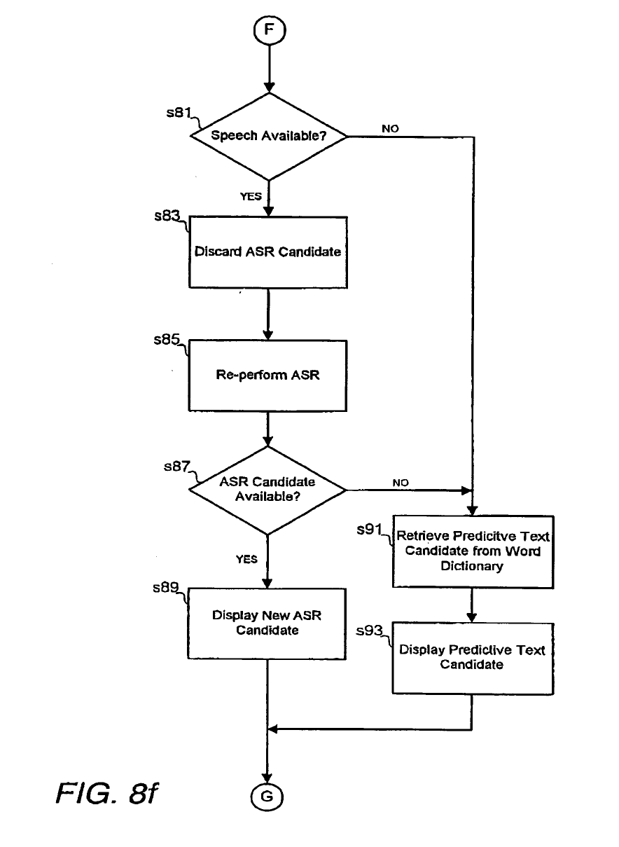

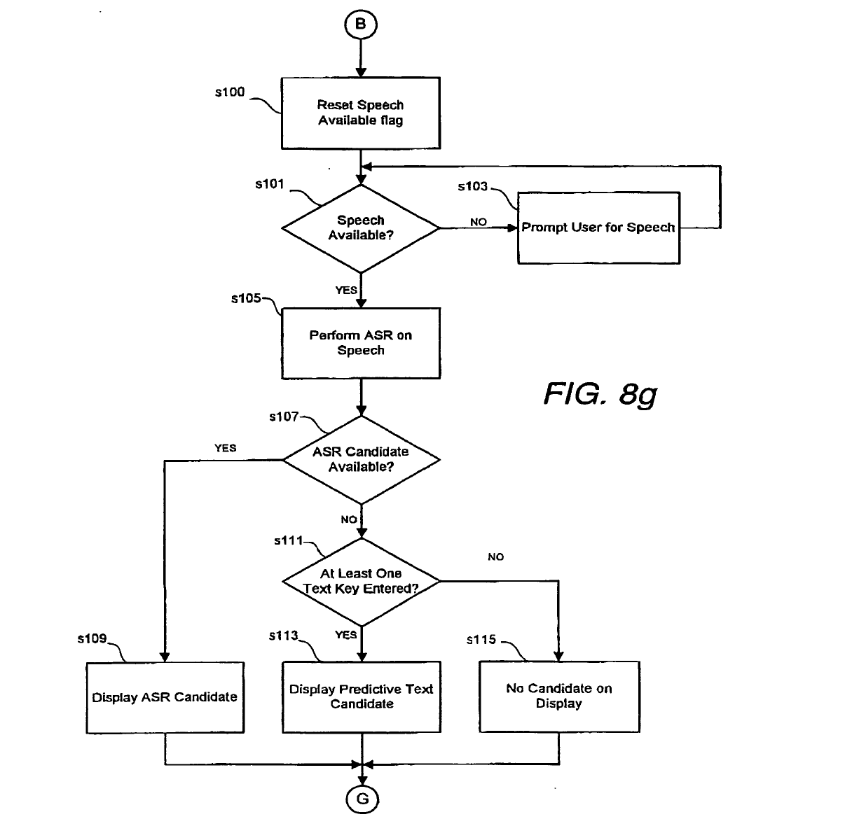

FIG. 8a is a flowchart illustrating the processing steps performed by a control unit shown in FIG. 2;

FIG. 8b is a flowchart illustrating the processing steps performed by the control unit when the control unit receives an input from a keyboard processor shown in FIG. 2;

FIG. 8c is a flowchart illustrating the processing steps performed by the control unit upon receipt of a confirmation signal;

FIG. 8d is a flowchart illustrating the processing steps performed by the control unit upon receipt of a cancel signal;

FIG. 8e is a flowchart illustrating the processing steps performed by the control unit upon receipt of a shift signal;

FIG. 8f is a flowchart illustrating the processing steps performed by the control unit upon receipt of a text key signal;

FIG. 8g is a flowchart illustrating the processing steps performed by the control unit when the control unit receives an input from a speech input button shown in FIG. 2; and

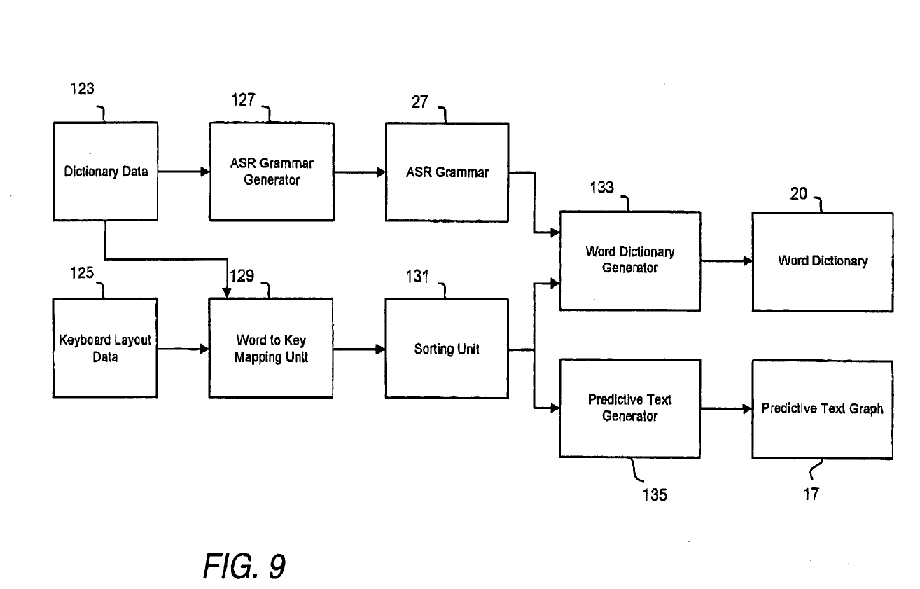

FIG. 9 is a block diagram illustrating the functional blocks of a system used to generate the predictive text graph and the word dictionary used by the text editor shown in FIG. 2.

### OVERVIEW

FIG. 1 illustrates a cellular telephone 1 having a text editor (not shown) embodying the present invention. The cellular telephone 1 includes a display 5, a speaker 7 and a microphone 9. The cellular telephone 1 also has an ambiguous keyboard 2, including keys 3-1 to 3-10 for entry of letters and numbers and keys 3-1 to 3-17 for controlling the operation of the cellular telephone 1, as defined in the following table:

| KEY | NUMBER | LETTERS | FUNCTION |
|---|---|---|---|
| 3-1 | 1 | — | Punctuation |
| 3-2 | 2 | abc | — |
| 3-3 | 3 | def | — |
| 3-4 | 4 | ghi | — |
| 3-5 | 5 | jkl | — |
| 3-6 | 6 | mno | — |
| 3-7 | 7 | pqrs | — |
| 3-8 | 8 | tuv | — |
| 3-9 | 9 | wxyz | — |
| 3-10 | 0 | — | space |
| 3-11 | — | — | spell |
| 3-12 | — | — | caps |
| 3-13 | — | — | confirm |
| 3-14 | — | — | cancel |
| 3-15 | — | — | shift |
| 3-16 | — | — | send/make call |
| 3-17 | — | — | END CALL |

The telephone 1 also includes a speech input button 4 for informing the telephone 1 when control speech is being or is about to be entered by the user via the microphone 9.

The text editor can operate in a conventional manner using predictive text. However, in this embodiment the text editor also includes an automatic speech recognition unit (not shown), which allows the text editor to be able to use the user's speech to disambiguate key strokes made by the user on the ambiguous keyboard 2 and to reduce the number of key strokes that the user has to make to enter a word into the text editor. In operation, the text editor uses key strokes input by the user to confine the recognition vocabulary used by the automatic speech recognition unit to decode the user's speech. The text editor then displays the recognized word on the display 5 thereby allowing the user to accept or reject the recognized word. If the user rejects the recognized word by typing further letters of the desired word, then the text editor can re-perform the recognition, using the additional key presses to further limit the vocabulary of the speech recognition unit In the worst case, therefore, the text editor will operate as well as a conventional text editor, but in most cases the use of the speech information will allow the correct word to be identified much earlier (i.e. with less keystrokes) than with a conventional text editor.

Text Editor

FIG. 2 is a schematic block diagram showing the main components of the text editor 11 used in this embodiment. As shown, the text editor 11 includes a keyboard processor 13 which receives an ID signal from the keyboard 2 each time the user presses a key 3 on the keyboard 2, which ID signal identifies the particular key 3 pressed by the user. The received key ID and data representative of the sequence of key presses that the user has previously entered since the last end of word identifier (usually identified by the user pressing the space key 3-10) is then used to address a predictive text graph 17 to determine data identifying the most likely word that the user wishes to input The data representative of the sequence of key presses that the user has previously entered is stored in a key register 14, and is updated with the most recent key press after it has been used to address the predictive text graph 17

The keyboard processor 13 then passes the data identifying the most likely word to the control unit 19 which uses the data to determine the text for the predicted word from a word dictionary 20. The control unit 19 then stores the text for the predicted word in an internal memory (not shown) and then outputs the text for the predicted word on the display 5. In this embodiment the stem of the predicted word (defined as being the first i letters of the word, where i is the number of key presses made by the user when entering the current word on the keyboard 2) is displayed in bold text and the remainder of the predicted word is displayed in normal text. This is illustrated in FIG. 1 for the current predicted word “abstract” after the user has pressed the key sequence “22” FIG. 1 also shows that, in this embodiment, the cursor 10 is positioned at the end of the stem 12.

In this embodiment, when the key ID for the latest key press and the data representative of previous key presses is used to address the predictive text graph 17, this also gives data identifying all possible words known to the text editor 11 that correspond to the key sequence entered by the user. The keyboard processor 13 passes this “possible word data” to an activation unit 21 which uses the data to constrain the words that the automatic speech recognition (ASR) unit 23 can recognize. In this embodiment, the ASR unit 23 is arranged to be able to discriminate between several thousand words pronounced in isolation. Since computational resources (both processing power and memory) on a cellular telephone 1 are limited, the ASR unit 23 compares the input speech with phoneme based models 25 and the allowed sequences of the phoneme based models 25 are constrained to define the allowed words by an ASR grammar 27. Therefore, in this embodiment, the activation unit 21 uses the possible word data to identify, from the word dictionary 20, the corresponding portions of the ASR grammar 27 to be activated.

If the user then presses the speech button 4, the control unit 19 is informed that speech is about to be input via the microphone 9 into a speech buffer 29. The control unit 19 then activates the ASR unit 23 which retrieves the speech from the speech buffer 29 and compares it with the appropriate phoneme based models 25 defined by the activated portions of the ASR grammar 27. In this way, the ASR unit 23 is constrained to compare the input speech only with the sequences of phoneme based models 25 that define the possible words identified by the keyboard processor 13, thereby reducing the processing burden and increasing the recognition accuracy of the ASR unit 23.

The ASR unit 23 then passes the recognized word to the control unit 19 which stores and displays the recognized word on the display 5 to the user. The user can then accept the recognized word by pressing the accept or confirmation key 3-13 on the keyboard 2. Alternatively, the user can reject the recognized word by pressing the key 3 corresponding to the next letter of the word that they wish to enter. In response, the keyboard processor 13 uses the entered key, the data representative of the previous key presses for the current word and the predictive text graph 17 to update the predicted word and outputs the data identifying the updated predicted word to the control unit 19 as before. The keyboard processor 13 also passes the data identifying the updated list of possible words to the activation unit 21 which reconstrains the ASR grammar 27 as before. In this embodiment, when the control unit 19 receives the data identifying the updated predicted word from the keyboard processor 13, it does not use it to update the display 5, since there is speech for the current word being entered in the speech buffer 29. The control unit 19, therefore, re-activates the ASR unit 23 to reprocess the speech stored in the speech buffer 29 to generate a new recognised word. The ASR unit 23 then passes the new recognised word to the control unit 19 which displays the new recognised word to the user on the display 5. This process is repeated until the user accepts the recognized word or until the user has finished typing the word on the keyboard 2.

A brief description has been given above of the operation of the text editor 11 used in this embodiment. A more detailed description will now be given of the operation of the main units in the text editor 11 shown in FIG. 2.

Keyboard Processor

FIG. 3 is flow chart illustrating the operation of the keyboard processor 13 used in this embodiment. As shown, at step s1, the keyboard processor 13 checks to see if a key 3 on the keyboard 2 has been pressed by the user. When a key press is detected, the processing proceeds to step s3 where the keyboard processor 13 checks to see if the user has just pressed the confirmation key 3-13 (by comparing the received key ID with the key ID associated with the confirmation key 3-13). If he has then, at step s5, the keyboard processor 13 sends a confirmation signal to the control unit 19 and then resets the activation unit 21 and its internal register 14 so that they are ready for the next series of key presses to be input by the user for the next word. The processing then returns to step s1.

If the keyboard processor 13 determines at step s3 that the confirmation key 3-13 was not pressed, then the processing proceeds to step s7 where the keyboard processor 13 determines if the cancel key 3-14 has just been pressed. If it has, then the keyboard processor 13 proceeds to step s9 where it sends a cancel signal to the control unit 19 so that the current predicted or recognised word is removed from the display S and so that the speech can be deleted from the buffer 29. In step s9 the keyboard processor 13 also resets the activation unit 21 and its internal register 14 so that they are ready for the. next word to be entered by the user. The processing then returns to step s1.

If at step s7, the keyboard processor 13 determines that the cancel key 3-14 was not pressed then the processing proceeds to step s11 where the keyboard processor 13 determines whether or not the shift key 3-15 has just been pressed. If it has, then the processing proceeds to step s13 where the keyboard processor 13 sends a shift control signal to the control unit 19 which causes the control unit 19 to move the cursor 10 one character to the right along the predicted or recognised word. The control unit 19 then identifies the letter following the current position of the cursor 10 on the displayed predicted or recognized word. For example, if the user presses the shift key 3-15 for the displayed message shown in FIG. 1, then the control unit 19 will identify the letter “s” of the currently displayed word “abstract”. The control unit 19 then returns the identified letter to the keyboard processor 13 which uses the identified letter and the previous key press data stored in the key register 14 to update the data identifying the possible words corresponding to the updated key sequence, using the predictive text graph 17. The keyboard processor 13 then passes the data identifying the updated possible words to the activation unit 21 as before. The processing then returns to step s1.

If at step s11, the keyboard processor 13 determines that the shift key 3-15 was not pressed, then the processing proceeds to step s15, where the keyboard processor 13 determines whether or not the space key 3-10 has just been pressed. If it has, then the keyboard processor 13 proceeds to step s17, where the keyboard processor 13 sends a space command to the control unit 19 so that it can update the display 5. At step s17, the keyboard processor 13 also resets the activation unit 21 and its internal register 14, so that they are ready for the next word to be entered by the user. The processing then returns to step s1.

If at step s15, the keyboard processor 13 determines that the space key 3-10 was not pressed, then the processing proceeds to step s19 where the keyboard processor 13 determines whether or not a text key (3-2 to 3-9) has been pressed. If it has, then the processing proceeds to step s21 where the keyboard processor 13 uses the key ID for the text key that has been pressed to update the predictive text and to inform the control unit 19 of the new key press and of the new predicted word. At step s21, the keyboard processor 13 also uses the latest text key 3 input to update the data identifying the possible words that correspond to the updated key sequence, which it passes to the activation unit 21 as before. The processing then returns to step s1.

If at step s19, the keyboard processor 13 determines that a text key (3-2 to 3-9) was not pressed then the processing proceeds to step s23 where the keyboard processor 13 checks to see if the user has pressed a key to end the text message, such as the send message key 3-16. If he has then the keyboard processor 13 informs the control unit 19 accordingly and then the processing ends. Otherwise the processing returns to step s1.

Although not discussed above, the keyboard processor 13 also has routines for dealing with the inputting of punctuation marks by the user via the key 3-1 and routines for dealing with left shifts and deletions etc. These routines are not discussed as they are not needed to understand the present invention.

Predictive Text

As discussed above, the keyboard processor 13 uses predictive text techniques to map the sequence of ambiguous key presses entered via the keyboard 2 into data that identities all possible words that can be entered by such a sequence. This is slightly different from existing predictive text systems which only determine the most likely word that corresponds to the entered key sequence. As discussed above, the keyboard processor 13 determines the data that identifies all of these words from the predictive text graph 17. FIG. 4 is a table illustrating part of the word data used to generate the predictive text graph 17 used in this embodiment. As those skilled in the art will appreciate, the predictive text graph 17 can be generated in advance from the data shown in FIG. 4 and then downloaded into the telephone at an appropriate time.

As shown in FIG. 4, the word data includes w rows of word entries 50-1 to 50-W, where W is the total number of words that will be known to the keyboard processor 13. Each of the word entries 50 includes a key sequence portion 51 which identifies the sequence of key presses required by the user to enter the word via the keyboard 2 of the cellular telephone 1. Each word entry 50 also has an associated index value 53 that is unique and which identifies the word corresponding to the word entry 50, and the text 55 for the word entry so. For example, for the word “abstract”, this has the index value of “6” and is defined by the user pressing the following key sequence “22787228”. As shown in FIG. 4, the word entries 50 are arranged in the table in numerical order based on the sequence of key-presses rather than alphabetical order based on the letters of the words. The important property of this arrangement is that given a sequence of key-presses, all of the words that begin with that sequence of key-presses are consecutive in the table. This allows all of the possible words corresponding to an input sequence of key-presses to be identified by the index value 53 for the first matching word in the table and the total number of matching words. For example, if the user presses the “2” key 3-2 twice, then the list of possible words corresponds to the word “cab” through to the word “actions” and can be identified by the index value “2” and the range “8”.

Part of the predictive text graph 17 generated from the word data shown in FIG. 4 is shown in a tree structure in FIG. 5a. As shown, the predictive text graph 17 includes a plurality of nodes 81-1 to 81-M and a number of arcs, some of which are referenced 83, which connect the nodes 81 together in a tree structure. Each of the nodes 81 in the predictive text graph 17 corresponds to a unique sequence of key presses and the arc extending from a parent node to a child node is labelled with the key ID for the key press required to progress from the parent node to the child node.

As shown in FIG. 5a, in this embodiment, each node 81 includes a node number N₁ which identifies the node 81. Each node 81 also includes three integers (j, k, l), where j is the value of the word index 53 shown in FIG. 4 for the first word in the table whose key sequence 51 starts with the sequence of key-presses associated with that node; k is the number of words in the table whose key sequence 51 starts with the sequence of key-presses associated with the node; and 1 is the value of the word index 53 of the most likely word for the sequence of key-presses associated with the node. As with conventional predictive text systems, the most likely word matching a given sequence of key-presses is determined in advance by measuring the frequency of occurrence of words in a large corpus of text.

As those skilled in the art will appreciate, the predictive text graph 17 shown in FIG. 5a is not actually stored in the mobile telephone 1 in such a graphical way. Instead, the data represented by the nodes 81 and arcs 83 shown in FIG. 5a are actually stored in a data array, like the table shown in FIG. 5b. As shown, the table includes M rows of node entries 90-1 to 90-M, where M is the total number of nodes 81 in the text graph 17. Each of the node entries 90 includes the node data for the corresponding node 81. As shown, the data stored for each node includes the node number (Nᵢ) 91 and the j, k and l values 92, 93 and 94 respectively. Each of the node entries 90 also includes parent node data 97 that identifies its parent node. For example, the parent node for node N₂ is node N₁. Each node entry 90 also includes child node data 99 which identifies the possible child nodes from the current node and the key press associated with the transition between the current node and the corresponding child node. For example, for node N₂, the child node data 99 includes a pointer to node N₃ if the next key press entered by the user corresponds to the “2” key 3-2; a pointer to node N₁₂ if the next key press entered by the user corresponds to the “3” key 3-3; and a pointer to node N₂₃ if the next key press entered by the user corresponds to the “9” key 3-9. Where there are no child nodes for a node, the child node data 99 for that node is left empty.

During use, the keyboard processor 13 stores the node number 91 identifying the sequence of key presses previously entered by the user for the current word, in the key register 14. If the user then presses another one of the text input keys 3-2 to 3-9, then the keyboard processor 13 uses the stored node number 91 to find the corresponding node entry 90 in the text graph 17. The keyboard processor 13 then uses the key ID for the new key press to identify the corresponding child node from the child node data 99. For example, if the user has previously entered the key sequence “22” then the node number 91 stored in the register 14 will be for node N₂, and if the user then presses the “8”0 key, then the keyboard processor 13 will identify (from the child node data 99 for node entry 90-3) that the child node for that key-press is node N₉. The keyboard processor 13 then uses the identified child node number to find the corresponding node entry 90, from which it reads out the values of j, k and l. For the above example, when the child node is N₉ the node entry is 90-9 and the value of j is 7 indicating that the first word that starts with the corresponding sequence of key-presses is the word “action”; the value of k is 3 indicating that there are only three words in the table shown in FIG. 4 which start with this sequence of key-presses; and the value of l is 7, indicating that the most likely word that is being input given this sequence of key-presses is the word “action”.

After the keyboard processor 13 has determined the values of j, k and l, it updates the node number 91 stored in the key register 14 with the node number for the child node just identified (which in the above example is the node number 90-9 for node N₉) and outputs the j and k values to the activation unit 21 and the l value to the control unit 19.

The activation unit 21 then uses the received values of j and k to access the word dictionary 20 to determine which portions of the ASR grammar 27 need to be activated. In this embodiment, the word dictionary 20 is formed as a table having the text 55 of all of the words shown in FIG. 4 together with the corresponding index 53 for those words. The word dictionary 20 also includes, for each word, data identifying the portion of the ASR grammar 27 which corresponds to that word, which allows the activation unit 21 to be able to activate the portions of the ASR grammar 27 corresponding to the possible word data (identified by j and k). Similarly, the control unit 19 uses the received value of 1 to address the word dictionary 20 to retrieve the text 55 for the identified word predicted by the keyboard processor 13. The control unit 19 also keeps track of how many key-presses have been made by the user so that it can control the position of the cursor 10 on the display 5 so that it appears at the end of the stem of the currently displayed word.

ASR Grammar

As discussed above, in this embodiment, the automatic speech recognition unit 23 recognises words in the input speech signal by comparing it with sequences of phoneme-based models 25 defined by the ASR grammar 27. In this embodiment, the ASR grammar 27 is optimised into a “phoneme tree” in which phoneme models that belong to different words are shared among a number of words. This is illustrated in FIG. 6a which shows how a phoneme tree 100 can define different words—in this case the words “action”, “actions”, “actionable” and “abstract”. As shown, the phoneme tree 100 is formed by a number of nodes 101-0 to 101-15, each of which has a phoneme label that identifies the corresponding phoneme model. The nodes 101 are connected to other nodes 101 in the tree by a number of arcs 103-1 to 103-19. Each branch of the phoneme tree 100 ends with a word node 105-1 to 105-4 which defines the word represented by the sequence of models along the branch from the initial root node 101-0 (representing silence). The phoneme tree 100 defines through the interconnected nodes 101, which sequences of phoneme models the input speech is to be compared with. In order to reduce the amount of processing, the phoneme tree 100 shares the models used for words having a common root, such as for the words “action” and “actions”.

As those skilled in the art of speech recognition will appreciate, the use of such a phoneme tree 100 reduces the burden on the automatic speech recognition unit 23 to compare the input speech with the phoneme based models 25 for all the words in the ASR vocabulary. However, in order to obtain good accuracy, context dependent phoneme-based models 25 are preferably used. In particular, during normal speech, the way in which a phoneme is pronounced depends on the phonemes spoken before and after that phoneme. The use of “tri-phone” models which store a model for sequences of three phonemes are often used. However, the use of such tri-phone models reduces the optimisation achieved in using the phoneme tree shown in FIG. 6a. In particular, if tri-phone models are used then the model for “n” in the word “action” could not be shared with the model for “n” in the words “actions” and “actionable”. In fact there would need to be three different tri-phone models: “sh−n+sil”, “sh−n+z” and “sh−n+ax” (where the notation x−y+z means that the phone y has left context x and right context z). However, since in a tree structure every node 101 (corresponding to a phoneme model) has exactly one parent node, the left context can always be preserved. For the nodes with only one child, also the right context can be preserved. For nodes that have more than one child, bi-phone models are used with specified left context and open (unspecified) right context. The final phoneme tree 100 for the words shown in FIG. 6a is shown in FIG. 6b. As illustrated, each of the nodes 101 includes a phoneme label which identifies the corresponding tri-phone or bi-phone model stored in the phoneme-based models 25.

As discussed above, the list of words recognisable by the automatic speech recognition unit 23 varies depending on the output of the keyboard processor 13. Any word recognised by the automatic speech recognition unit 23 must in fact satisfy the constraints imposed by the sequence of keys entered by the user As discussed above, this is achieved by the activation unit 21 controlling which portions of the ASR grammar 27 are active and therefore used in the recognition process. This is achieved, in this embodiment, by the activation unit 21 activating the appropriate arcs 103 in the ASR grammar 27 for the possible words identified by the keyboard processor 13. In this embodiment, the identifiers for the arcs 103 associated with each word are stored within the word dictionary 20 so that the activation unit 21 can retrieve and can activate the appropriate arcs 103 without having to search for them in the ASR grammar 27.

FIG. 7 is a table illustrating the content of the word dictionary 20 used in this embodiment. As shown, the word dictionary 20 includes the index 53 and the word text 55 of the table shown in FIG. 4. The word dictionary 20 also includes arc data 57 identifying the arcs 103 for the corresponding word in the ASR grammar 27. For example, for the word “action”, the arcs data 57 includes arcs 103-1 to 103-5. The activation unit 21 can therefore identify the relevant arcs 103 to be activated using the j and k values received from the keyboard processor 13 to look up the corresponding arc data 57 in the word dictionary 20. In particular, the activation unit uses the value of j received from the keyboard processor 13 to identify the first word in the word dictionary 20 that may correspond to the input sequence of key presses. The activation unit 21 then uses the k value received from the keyboard processor 13 to select the k words in the word dictionary (starting from the first word identified using the received j value). The activation unit 21 then reads out the arc data 57 from the selected words and uses that arc data 57 to activate the corresponding arcs in the ASR grammar 27.

FIG. 6b illustrates the selective activation of the arcs 103 by the activation unit 21, when the arcs 103-1 to 103-11 for the. words “action”, “actions” and “actionable” are activated and the arcs 101-12 to 101-19 associated with the word “abstract” are not activated and are shown in phantom.

Control Unit

FIG. 8, comprising FIGS. 8a to 8g are flowcharts illustrating the operation of the control unit 19 used in this embodiment. As shown in FIG. 8a, the control unit 19 continuously checks in steps s31 and s33 whether or not it has received an input from the keyboard processor 13 or if the speech button 4 has been pressed. If the control unit detects that it has received an input from the keyboard processor 13, then the processing proceeds to “A” shown at the top of FIG. 8b, otherwise if the control unit 19 determines that the speech input button 4 has been pressed then it proceeds to “B” shown at the top of FIG. 8g.

As shown in FIG. 8b, if the control unit detects that it has received an input from the keyboard processor 13, then the processing proceeds to step s41 where the control unit determines whether or not it has received a confirmation signal from the keyboard processor 13. If it has received a confirmation signal, then the processing proceeds to “C” shown in FIG. 8c, where the control unit 19 updates the display 5 to confirm the currently displayed candidate word. The processing then proceeds to step s53 where the control unit resets a “speech available flag” to false, indicating that speech is no longer available for processing by the ASR unit 23. The processing then proceeds to step s55 where the control unit 19 resets any predictive text candidate stored in its internal memory. The processing then returns to step s31 shown in FIG. 8a.

If at step s41, the control unit 19 determines that a confirmation signal was not received, then the processing proceeds to step s43 where the control unit 19 checks to see if a cancel signal has been received. If it has, then the processing proceeds to “D” shown in FIG. 8d As shown, in this case, the control unit 19 resets, in step s61, the speech available flag to false and then, in step s63, resets the predictive text candidate by deleting it from its internal memory. The control unit 19 then updates the display 5 to remove the current predicted word being entered by the user. The processing then returns to step s31 shown in FIG. 8a.

If at step s43, the control unit determines that a cancel signal has not been received, then at step s45, the control unit determines whether or not it has received a shift signal. If it has, then the processing proceeds to “E” shown in FIG. Be As shown, at step s71, the control unit 19 identifies the letter following the current cursor position. The processing then proceeds to step s73 where the control unit 19 returns the identified letter to the keyboard processor 13, so that the keyboard processor 13 can update its predictive text routine. The processing then proceeds to step s75 where the control unit 19 updates the cursor position on the display 5 by moving the cursor 10 one character to the right. The processing then returns to step s31 shown in FIG. 8a.

If at step s45, the control unit 19 determines that a shift signal has not been received, then the processing proceeds to step s47 where the control unit 19 determines whether or not it has received a text key and a predictive text candidate from the keyboard processor 13. If it has, then the processing proceeds to “F” shown at the top of FIG. 8f. As shown, in this case, at step 981, the control unit 19 determines whether or not speech is available in the speech buffer 29 (from the status of the “speech available flag”). If speech is available, then the processing proceeds to step s83 where the control unit 19 discards the current ASR candidate and then, in step s85, instructs the ASR unit 23 to re-perform the automatic speech recognition on the speech stored in the speech buffer 29. In this way, the speech recognition unit 23 will re-perform the speech recognition in light of the updated predictive text generated by the keyboard processor 13. The processing then proceeds to step s87 where the control unit 19 determines whether or not a new ASR candidate is available. If it is, then the processing proceeds to step s89 where the new ASR candidate is displayed on the display 5. The processing then returns to step s31 shown in FIG. 8a. If, at step s81 the control unit 19 determines that speech is not available or if at step s87 the control unit 19 determines that an ASR candidate is not available, then the processing proceeds to step s91 where the control unit 19 uses the predictive text data (the value of the integer 1) received from the keyboard processor 13 to retrieve the corresponding text 55 from the word dictionary 20. The processing then proceeds to step s93 where the control unit 19 displays the predictive text candidate on the display S The processing then returns to step s31 shown in FIG. 8a.

If at step s47, the control unit 19 determines that a text key and predictive text candidate have not been received from the keyboard processor, then the processing proceeds to step s49 where the control unit 19 determines whether or not an end text message signal has been received. If it has, then the processing ends, otherwise, the processing returns to step s31 shown in FIG. 8a.

Although not shown in FIG. 8, the control unit 19 will also have routines for dealing with the inputting of punctuation marks, the shifting of the cursor to the left and the deletion of characters from the displayed word. Again, these routines are not shown because they are not relevant to understanding the present invention.

If at step s33, the control unit 19 determines that the speech input button 4 has been pressed, then the processing proceeds to “B” shown at the top of FIG. 8g. As shown, in step S100, the control unit 19 initially resets the speech available flag to false so that previously entered speech stored in the speech buffer 29 is not processed by the ASR unit 23. In steps S101 and S103, the control unit prompts the user to input speech and waits until new speech has been entered. Once speech has been input by the user and the speech available flag has been set, the processing proceeds to step s105 where the control unit 19 instructs the ASR unit 23 to perform speech recognition on the speech stored in the speech buffer 29. The processing then proceeds to step s107 where the control unit 19 checks to see if an ASR candidate word is available. If it is, then the processing proceeds to step s109 where the control unit 19 displays the ASR candidate word on the display 5. The processing then returns to step s31 shown in FIG. 8a. If, however, an ASR candidate word is not available at step s107, then the processing proceeds to step sill where the control unit 19 checks to see if at least one text key 3 has been pressed. If the user has not made any key presses, then the processing proceeds to step s115 where the control unit 19 displays no candidate word on the display 5 and the processing then returns to step s31 shown in FIG. 8a. If, however, the control unit 19 determines at step s111 that the user has pressed one or more keys 3 on the keyboard 2, then the processing proceeds to step s113 where the control unit 19 displays the predicted candidate word identified by the keyboard processor 13. The processing then returns to step s31 shown in FIG. 8a.

A detailed description of a cellular telephone 1 embodying the present invention has been given above. As described, the cellular telephone 1 includes a text editor 11 that allows users to input text messages into the cellular telephone 1 using a combination of voice and typed input. Where keystrokes have been entered into the telephone 1, the automatic speech recognition unit 23 was constrained in accordance with the keystrokes entered. Depending on the number of keystrokes entered, this can significantly increase the recognition accuracy and reduce recognition time. To achieve this, in the above embodiment, the predictive text graph included data identifying all words which may correspond to any given sequence of input characters and a word dictionary was provided which identified the portions of the ASR grammar 27 that were to be activated for a given sequence of key presses. As discussed above, this data is calculated in advance and then stored or downloaded into the cellular telephone 1.

FIG. 9 is a block diagram illustrating the main components used to generate the word dictionary 20 and the predictive text graph 17 used in this embodiment. As shown, these data structures are generated from two base data sources—dictionary data 123 which identifies all the words that will be known to the keyboard processor 13 and to the ASR unit 23; and keyboard layout data 125 which defines the relationship between key presses and alphabetical characters. As shown in FIG. 9, the dictionary data 123 is input to an ASR grammar generator 127 which generates the ASR grammar 27 discussed above. The dictionary data 123 is also input to a word-to-key mapping unit 129 which uses the keyboard layout data 125 to determine the sequence of key presses required to input each word defined by the dictionary data 123 (i.e. the key sequence data 51 shown in FIG. 4). Since the dictionary data 123 will usually store the words in alphabetical order, the words and the corresponding key sequence data 51 generated by the word-to-key mapping unit 129 is likely to be in alphabetical order. This word data and key sequence data 51 is then sorted by a sorting unit 131 into numerical order based on the sequence of key presses required to input the corresponding word. The sorted list of words and the corresponding key presses is then output to a word dictionary generator 133 which generates the word dictionary 20 shown in FIG. 7. The sorted list of words and corresponding key presses is also output to a predictive text generator 135 which generates the predictive text graph 17 shown in FIG. 8b.

Modifications and Alternatives

In the above embodiment, a cellular telephone was described which included a predictive text keyboard processor which operated to predict words being input by the user. The key presses entered by the user were also used to constrain the recognition vocabulary used by an automatic speech recognition unit In an alternative embodiment, the text editor may include a conventional “multi-tap” keyboard processor in which text prediction is not carried out. In such an embodiment, the confirmed letters entered by the user can still be used to constrain the ASR vocabulary used during a recognition operation. In such an embodiment, because letters are being confirmed by the keyboard processor, the data stored in the word dictionary is preferably sorted alphabetically so that the relevant words to be activated in the ASR grammar again appear consecutively in the word dictionary.

In the above embodiment, the predictive text graph included, for each node in the graph, not only data identifying the predicted word corresponding to the sequence of key presses, but also data identifying the first word in the word dictionary that corresponds to the sequence of key presses and the number of words within the dictionary that correspond to the sequence of key presses. The activation unit used this data to determine which arcs within the ASR grammar should be activated for the recognition process. As those skilled in the art will appreciate, it is not essential for the keyboard processor to identify the first word within the word dictionary which corresponds to the sequence of key presses. Indeed, it is not essential to store the “j” and “k” data in each node of the predictive text graph. Instead, the keyboard processor may simply identify the most likely word to the activation unit, provided the data stored in the word dictionary for that most likely word includes the arcs for all words corresponding to that input key sequence. For example, referring to FIG. 4, if the input key sequence corresponds to “228” and the most likely word is the word “action”, then provided the arc data stored in the word dictionary for the word “action” includes the arcs within the ASR grammar for the words actionable and actions, then the activation unit can still activate the relevant portions of the ASR grammar.

In the above embodiment, the text editor was arranged to display the full word predicted by the keyboard processor or the ASR candidate word for confirmation by the user. In an alternative embodiment, only the stem of the predicted or ASR candidate word may be displayed to the user. However, this is not preferred, since the user will still have to make further key-presses to enter the correct word.

In the above embodiment, the text editor included an embedded automatic speech recognition unit. As those skilled in the art will appreciate, this is not essential. The automatic speech recognition unit may be provided separately from the text editor and the text editor may simply communicate commands to the separate automatic speech recognition unit to perform the recognition processing.

In the above embodiment, the word dictionary data and the predictive text graph were stored in two separate data stores. As those skilled in the art will appreciate, a single data structure may be provided containing both the predictive text graph data and the word dictionary data.

In such an embodiment, the keyboard processor, the activation unit and the control unit would then access the same data structure

In the above embodiment, the automatic speech recognition unit stored a word grammar and phoneme-based models. As those skilled in the art will appreciate, it is not essential for the ASR unit to be a phoneme-based device. For example, the ASR unit may be a word-based automatic speech recognition unit. In this case, however, if the ASR dictionary is to be the same size as the dictionary for the keyboard processor then this will require a substantial memory to store all of the word models. Further, in such an embodiment, the control unit may be arranged to limit the operation of the ASR unit so that speech recognition is only performed provided the possible words corresponding to the sequence of key-presses is below a predetermined number of words. This will speed up the recognition processing an devices having limited memory and/or processing power.

In the above embodiment, the automatic speech recognition unit used the same grammar (i.e. dictionary words) as the keyboard processor. As those skilled in the art will appreciate, this is not essential. The keyboard processor or the ASR unit may have a larger vocabulary than the other.

In the above embodiment, when displaying a predicted or

ASR candidate word to the user, the control unit placed the cursor at the end of the stem of the displayed word allowing the user to either confirm the word or to press the shift key to accept letters in the displayed word. As those skilled in the art will appreciate, this is not the only way that the control unit can display the candidate word to the user. For example, the control unit may be arranged to display the whole predicted or candidate word and place the cursor at the end of the word. The user can then accept the predicted or candidate word simply by pressing the space key. Alternatively, the user can use a left-shift key to go back and effectively reject the predicted or candidate word. In such an embodiment, the ASR unit may be arranged to re-perform the recognition processing excluding the rejected candidate word.

In the above embodiment, the control unit only displayed the most likely word corresponding to the ambiguous set of input key presses. In an alternative embodiment, the control unit may be arranged to display a list of candidate words (for example in a pop-up list) which the user can then scroll through to select the correct word.

In the above embodiment, when the user rejects an automatic speech recognition candidate word by, for example, typing the next letter of the desired word, the control unit caused the ASR unit to re-perform the speech recognition processing. Additionally, as those skilled in the art will appreciate, the control unit can also inform the activation unit that the previous ASR candidate word was not the correct word and that therefore, the corresponding arcs for that word should not be activated when taking into account the new key press. This will ensure that the automatic speech recognition unit will not output the same candidate word to the control unit when re-performing the recognition processing.

Although not described in the above embodiment, the text editor will also allow users to be able to “switch off” the predictive text nature of the keyboard processor. This will allow users to be able to use the multi-tap technique to type in words that may not be in the dictionary.

In the above embodiment, the predictive text graph, the word dictionary and the ASR grammar were downloaded and stored in the cellular telephone in advance of use by the user As those skilled in the art will appreciate, it is possible to allow the user to update or to add words to the predictive text graph, the word dictionary and/or the ASR grammar. This updating may be done by the user entering the appropriate data via the keypad or by downloading the update data from an appropriate service provider.

In the above embodiment, if the automatic speech recognition unit did not recognise the correct word, then the controller can instruct the ASR unit to re-perform the recognition processing after the user has typed in one or more further letters of the desired word. Alternatively, if the ASR unit determines that the quality of the input speech is insufficient, it can inform the control unit which can then prompt the user to input the speech again.

In the above embodiment, the list of arcs for a word within the ASR grammar were stored within the word dictionary and the activation unit used the arc data to activate only those arcs for the possible words identified by the keyboard processor. As those skilled in the art will appreciate, this is not essential. The keyboard processor may simply inform the activation unit of the possible words and the activation unit can then use the identified words to backtrack through the ASR grammar to activate the appropriate arcs. However, such an embodiment is not preferred, since the activation unit would have to search through the ASR grammar to identify and then activate the relevant arcs.

In the above embodiment, the key-presses entered by the user on the keyboard were used to confine the recognition vocabulary of the automatic speech recognition unit. As those skilled in the art will appreciate, this is not essential. For example, the keyboard processor may operate independently of the ASR unit and the controller may be arranged to display words from both the keyboard processor and the ASR unit. In such an embodiment, the controller may be arranged to give precedence to either the ASR candidate word or to the text input by the keyboard processor. This precedence may also depend on the number of key-presses that the user has made. For example, when only one or two key-presses have been made, the controller may place more emphasis on the ASR candidate word, whereas when three or four key-presses have been made the controller may place more emphasis on the predicted word generated by the keyboard processor.

In the above embodiment, the activation unit received data that identified words within a word dictionary corresponding to the input key-presses. The activation unit then retrieved arc data for those words which it used to activate the corresponding portions of the ASR grammar. In an alternative embodiment, the activation unit may simply receive a list of the key-presses that the user has entered. In such an embodiment, the word dictionary could include the sequences of key-presses together with the corresponding arcs within the ASR grammar. The activation unit would then use the received list of key-presses to look-up the appropriate arc data from the word dictionary, which it would then use to activate the corresponding portions of the ASR grammar.

In the above embodiment, a cellular telephone has been described which allows users to enter text using Roman letters (i.e. the characters used in written English). As those skilled in the art will appreciate the present invention can be applied to cellular telephones which allow the inputting of the symbols used in any language such as, for example, Arabic or Japanese symbols.

In the above embodiment, the automatic speech recognition unit was arranged to recognise words and to output recognised words to the control unit. In an alternative embodiment, the automatic speech recognition unit may be arranged to output a sequence (or lattice) of phonemes or other sub-word units as a recognition result. In such an embodiment, for any given input key sequence, the keyboard processor would output the different possible sequences of symbols to the control unit. The control unit can then convert each sequence of symbols into a corresponding sequence (or lattice) of phonemes (or other sub-word units) which it can then compare with the sequence (or lattice) of phonemes (or sub-word units) output by the automatic speech recognition unit. The control unit can then use the results of this comparison to identify the most likely sequence of symbols corresponding to the ambiguous input key sequence. The control unit can then display the appropriate stem or word corresponding to the most likely sequence.

A cellular telephone device was described which included a text editor for generating text messages in response to key-presses on an ambiguous keyboard and in response to speech recognised by a speech recogniser. The text editor and the speech recogniser may be formed from dedicated hardware circuits. Alternatively, the text editor and the automatic speech recognition circuit may be formed by a programmable processor which operates in accordance with stored software instructions which cause the processor to operate as the text editor and the speech recognition circuit. The software may be pre-stored in a memory of the cellular telephone or it may be downloaded on an appropriate carrier signal from, for example, the telephone network.

1. A portable wire-less communication device comprising:
a plurality of keys for the input of symbols, wherein each of at least some of the keys is operable for the input of a plurality of different symbols;
a keyboard processor operable to generate text data in dependence upon the actuation of one or more of said keys by a user;
an automatic speech recogniser operable to recognise an input speech signal and to generate a recognition result; and
a controller responsive to the text data generated by said keyboard processor and responsive to said recognition result generated by said automatic speech recogniser to generate text.

2. A device according to claim 1, wherein said automatic speech recogniser includes a vocabulary which defines the possible words that can be recognised by the speech recogniser and wherein said speech recogniser is responsive to text data generated by the keyboard processor to restrict the speech recognition vocabulary prior to recognition processing of said speech signal.

3. A device according to claim 1, wherein said plurality of keys operable for the input of the plurality of different symbols form part of an ambiguous keyboard.

4. A device according to claim 2, wherein said keyboard processor is a predictive text editor.

5. A device according to claim 4, wherein said keyboard processor is operable, in response to actuation of said keys, to generate text data that defines predicted symbols intended by the user and operable to regenerate text data that defines re-predicted symbols in response to further key actuation.

6. A device according to claim 5, wherein said speech recogniser is operable to recognise said speech signal in dependence upon at least one of the predicted symbols defined by said text data generated by said keyboard processor and is operable, in response to a regeneration of a said text data by said keyboard processor, to re-perform speech recognition on the speech signal in dependence upon at least one of the predicted symbols defined by the re-generated text data.

7. A device according to claim 5, wherein said keyboard processor is operable to receive a key ID identifying a latest key pressed by the user and is operable to store previous key-press data indicative of the input key sequence for a current word being entered via the keys.

8. A device according to claim 7, further comprising a text graph which defines a mapping between previous key-press data and a latest key ID to text data identifying the most likely word corresponding to the input key sequence, and wherein said keyboard processor is operable to use the key ID for the latest key press and the stored previous key-press data to address said text graph to determine the text data identifying the most likely word corresponding to the input key sequence.

9. A device according to claim 8, wherein said text graph also defines a mapping between said previous key data and said latest key ID to data identifying possible words corresponding to the input key sequence and wherein said automatic speech recogniser is responsive to the data identifying possible words corresponding to an input key sequence to restrict the recognition process thereof.

10. A device according to claim 9, wherein said keyboard processor is operable to address said text graph using said previous key-press data and the current key ID to retrieve the data identifying possible words corresponding to the input key sequence and is operable to pass the data identifying the possible words to said automatic speech recogniser

11. A device according to claim 10, wherein said automatic speech recogniser is operable to restrict a vocabulary thereof in dependence upon the data identifying said possible words received from said keyboard processor.

12. A device according to claim 9, comprising a word dictionary having N word entries, each storing word data for a word, wherein the word entries are ordered in the word dictionary based on the input key sequence needed to enter the symbols for the word via said keys, wherein each word entry has an associated index value indicative of the order of the word entry in the dictionary, and wherein the text data identifying the most likely word comprises the index value of that word in said word dictionary.

13. A device according to claim 12, wherein said text data identifying possible words corresponding to the input key sequence comprises the index value for at least one word in the dictionary and a range of index values for words in the dictionary that are adjacent to said at least one word in the dictionary.

14. A device according to claim 13, wherein said text data identifying possible words comprises the index value for the first or last of the possible words within the dictionary and the number of words appearing immediately after or before the identified first or last word.

15. A device according to claim 1, wherein said controller is operable to activate said automatic speech recogniser in response to speech received by the user and is operable to reactivate the speech recogniser in response to updated text data received from said keyboard processor.

16. A device according to claim 1, wherein said automatic speech recogniser comprises a grammar which defines all possible words that can be recognised by the speech recogniser and model data for the words.

17. A device according to claim 16, wherein said model data comprises subword unit models and wherein said grammar defines a sequence of subword unit models for each word.

18. A device according to claim 17, wherein said model data comprises phoneme-based models.

19. A device according to claim 18, wherein said model data comprises a mixture of tri-phone and bi-phone models for one or more words in the grammar.

20. A device according to claim 16, further comprising an activation unit operable to enable or disable portions of the grammar selected in accordance with text data generated by said keyboard processor in response to actuation of said keys by the user

21. A device according to claim 1, further comprising a word dictionary comprising N word entries, each storing word data for a word, wherein the word entries are ordered in the word dictionary based on the input key sequence needed to enter the symbols for the word using said keys and wherein said automatic speech recogniser is operable to recognise said word in dependence upon the data stored in said word dictionary.

22. A portable wire-less communication device, comprising:
a keypad having a plurality of keys for the input of symbols, wherein each of at least some of the keys is operable for the input of a plurality of different symbols;
a text message generator responsive to keypad input to generate text for a text message; and
a speech recogniser responsive to voice input to determine a spoken word;
wherein:
the text message generator is responsive to the determination of a word by the speech recogniser to include the word in the text message.

23. A device according to claim 22, wherein the speech recogniser is operable to determine a word in dependence upon at least part of the content of the text message entered via the keypad.

24. A portable wire-less communication device, comprising:
a keypad having a plurality of keys for the input of symbols, wherein each of at least some of the keys is operable for the input of a plurality of different symbols;
a text message generator responsive to keypad input to generate text for a text message; and
a speech recogniser responsive to voice input to determine a spoken word;
wherein:
the speech recogniser is operable to determine a word in dependence upon at least part of the content of the text message entered via the keypad.

25. Apparatus for generating and sending text messages over a communication network, the apparatus comprising:
a plurality of keys for the input of symbols, wherein the number of keys is less than the number of symbols;
a predictive text generator responsive to actuation of the keys to predict symbols intended by the user and to add the symbols to a text message, and operable to re-predict symbols in response to further key actuation and to change the symbols in the text message in accordance with the re-prediction; and
a speech recogniser operable to generate text for the text message by:
recognising a word spoken by a user, such that the recognition is performed in dependence upon at least one symbol generated by the predictive text generator;
storing in memory the voice data of the word spoken by the user; and
in response to re-prediction of a symbol by the predictive text generator, re-performing speech recognition using the stored voice data and in dependence upon the re-predicted symbol.

26. A method of generating text on a portable wire-less communication device having a plurality of keys for the input of symbols, wherein each of at least some of the keys is operable for the input of a plurality of different symbols, the method comprising:
generating text data in dependence upon the actuation of one or more of said keys by a user;
using an automatic speech recogniser to recognise an input speech signal to generate a recognition result; and
generating text in dependence upon text data generated by the actuation of said one or more keys by the user and in dependence upon the recognition result generated by said speech recogniser.

27. A method according to claim 26, wherein the method is performed on a portable wire-less communication device according to any one of claims 1, 22, 24 and 25.

28. A data processing method comprising:
receiving text data representative of text for a plurality of words;
receiving mapping data defining a mapping between key-presses of an ambiguous keyboard and text symbols;
processing the text data and the mapping data to determine a key sequence for each word which defines the sequence of key-presses on said ambiguous keyboard which map to the text symbols corresponding to the word; and
sorting the respective text data for said plurality of words based on the key sequence determined for each word, to generate word dictionary data for use in an electronic device having such an ambiguous keyboard.

29. A method according to claim 28, wherein said sorting process orders the respective text data for each word based on an assigned order given to the keys of the ambiguous keyboard.

30. A method according to claim 29, wherein the keys of said ambiguous keyboard are assigned a numerical order and wherein said sorting process sorts the text data for each word based on the numerical order of each key sequence.

31. A method according to claim 28, further comprising a process of generating a signal carrying said word dictionary data.

32. A method according to claim 31, further comprising a process of recording said signal directly or indirectly on a recording medium.

33. A method according to claim 28, further comprising a process of processing said word dictionary data to generate data defining a predictive text graph which relates an input key sequence to data defining all words within said dictionary whose key sequence starts with said input key sequence.

34. A method according to claim 33, wherein said process of processing said word dictionary data generates data defining a predictive text graph which relates an input key sequence to data defining a most likely word corresponding to said input key sequence.

35. A method according to claim 33, further comprising a process of generating a signal carrying said data defining the predictive text graph.

36. A method according to claim 35, further comprising a process of recording said signal directly or indirectly on a recording medium.

37. A data processing method comprising:
receiving text data representative of text for a plurality of words;
receiving mapping data defining a mapping between key-presses of an ambiguous keyboard and text symbols;
processing the text data and the mapping data to determine a key sequence for each word which defines the sequence of key-presses on said ambiguous keyboard which map to the text symbols which correspond to the word;
receiving ASR grammar data identifying portions of the ASR grammar corresponding to each of said plurality of words; and
associating the determined key sequence for a word with the corresponding ASR grammar data for that word, to generate word dictionary data for use in an electronic device having such an ambiguous keyboard.

38. A method according to claim 37, further comprising a process of generating a signal carrying said word dictionary data.

39. A method according to claim 38, further comprising a process of recording said signal directly or indirectly on a recording medium.

40. A storage medium storing computer program instructions for programming a portable wire-less communication device to become configured as a device according to any one of claims 1 to 25.

41. A physically-embodied computer program product carrying computer program instructions for programming a portable wire-less communication device to become configured as a device according to any one of claims 1 to 25.
